(19) United States
(12) Patent Application Publication
(10) Pub. No.: US 2017/0286876 A1
(43) Pub. Date: Oct. 5, 2017

(54) SYSTEMS, DEVICES, AND METHODS FOR GENERATING A ROUTE FOR RELOCATING OBJECTS

(71) Applicant: Wal-Mart Stores, Inc., Bentonville, AR (US)

(72) Inventors: Jeremy Tingler, Bentonville, AR (US); David Scot Harlow, Rogers, AR (US); Alvin Scott Taulbee, Springdale, AR (US)

(21) Appl. No.: 15/474,467

(22) Filed: Mar. 30, 2017

Related U.S. Application Data
(60) Provisional application No. 62/317,020, filed on Apr. 1, 2016.

(51) Int. Cl. G06Q 10/04; G06K 7/10; G06Q 10/08; G06K 7/00

(52) U.S. Cl. CPC G06Q 10/047; G06K 7/0004; G06K 7/10366; G06Q 10/087

(57) ABSTRACT

Methodologies, systems, and computer-readable media are provided for generating routes for relocating objects. A computational device retrieves from a database object relocation data and relocation capacity data for each of a plurality of objects identified by an electronic scanning device at a first geographical location. The objects at the first geographical location are intended for relocation, and the object relocation data indicates possible geographical locations for receiving each of the objects. The relocation capacity data indicates an available capacity for each of the possible geographical locations. The computational device computes a relocation destination for each of those objects based on the relocation capacity data of each of the possible geographical locations. The computational device also generates a relocation route for relocating the objects based on the relocation destinations and transmits the relocation route to a mobile electronic device configured to interactively display the relocation route to a user.

### RELATED APPLICATIONS

This application claims priority to U.S. Provisional Patent Application Ser. No. 62/317,020 entitled “SYSTEMS, DEVICES, AND METHODS FOR GENERATING A ROUTE FOR RELOCATING OBJECTS,” filed on Apr. 1, 2016, the contents of which is hereby incorporated by reference in its entirety.

### BACKGROUND OF THE TECHNOLOGY

Physical objects can be associated with RFID tags and machine readable identifiers that can be read by an RFID reader or optical reader. In some instances, a computing terminal can record and store data relating to the objects associated with RFID tags or machine readable features.

### SUMMARY

In accordance with embodiments of the present disclosure, a system for generating a route for relocating objects is disclosed. The system includes a mobile electronic device including a processor, a display, a memory, and a wireless interface. The system also includes an area at a first geographic location at which objects to be relocated are deposited. The area includes a first RFID reader configured to identify each of a first subset of the objects associated with RFID tags as each of the objects in the first subset is deposited in the area. The area also includes an optical reader configured to identify each of a second subset of the objects deposited in the area.

The system also includes a computational device in communication with the mobile electronic device, the first RFID reader, and the optical reader. The computational device is configured to identify possible geographic locations for receiving each of the objects. The computational device is also configured to determine an available capacity at each of the possible geographic locations. The computational device is also configured to compute a relocation destination for each of the objects based on the available capacity at each of the possible geographic locations. The computational device is also configured to generate a relocation route for relocating the objects based on the relocation destination computed for each of the objects. The computational device is also configured to transmit the relocation route to the mobile electronic device.

The relocation route is received by the wireless interface of the mobile electronic device, and the processor of the mobile electronic device is configured to store the relocation route in memory and interactively render the relocation route on the display. In some embodiments, the processor of the mobile electronic device is configured to render an image of each relocation destination on the display when the processor determines that the mobile electronic device is in a proximity of each relocation destination based on wireless broadcasts from geographically distributed wireless access points that are received via the wireless interface of the mobile electronic device. In some embodiments, the mobile electronic device is configured to dynamically update a current location of the mobile electronic device with respect to the relocation route as the mobile electronic device travels along the relocation route.

In some embodiments, the system also includes a second RFID reader disposed at a second geographical location along the relocation route, and the computational device is further configured to update a second database in response to the second RFID reader identifying at least one of the objects in the first subset at the second geographical location, wherein the second database is updated to increment data associated with a physical quantity of the at least one of the objects at the relocation destination associated with the at least one of the objects.

In accordance with alternative embodiments of the present disclosure, a system for generating a route for relocating objects is disclosed including an area at a first geographic location at which objects to be relocated are deposited, the area including a first electronic scanning device configured to identify each of the objects to be relocated as each of the objects are deposited in the area. The system also includes a computational device configured to retrieve object relocation data and relocation capacity data from a first database for each of the objects identified by the first electronic scanning device, the object relocation data indicating possible geographic locations for receiving each of the objects and the relocation capacity data indicating an available capacity for each of the possible geographic locations. The computational device is also configured to compute a relocation destination for each of the objects based on the relocation capacity data for each of the possible geographic locations. The computational device is also configured to generate a relocation route for relocating the objects based on the relocation destination computed for each of the objects. The computational device is also configured to transmit the relocation route to a mobile electronic device configured to interactively display the relocation route to a user.

In some embodiments, the first electronic scanning device is an RFID reader, each of the objects has an RFID tag, and the RFID reader reads the RFID tag associated with each of the objects as each of the objects enters the area. In some embodiments, the computational device is further configured to update a second database in response to the objects being relocated to their respective relocation destinations, wherein, the second database is updated to increment data associated with a physical quantity of each of the objects at each relocation destination. In some embodiments, the system also includes a second electronic scanning device located at a second geographical location outside of the area, and the computational device is further configured to update a second database in response to the second electronic scanning device identifying at least a subset of the objects at the second geographic location. In some embodiments, the computational device is further configured to update the relocation capacity data in response to a change in the available capacity for at least one of the relocation destinations.

In some embodiments, the computational device is further configured to: retrieve updated relocation capacity data; compute a new relocation destination for at least one of the objects for which the relocation route was computed in response to the updated relocation capacity data; generate a new relocation route in response to the new relocation destination; and transmit the new relocation route to the mobile electronic device. In some embodiments, the computational device is further configured to omit at least one of the objects from the relocation route in response to a retrieval request for the at least one object from the first geographical location. In some embodiments, a set of objects having a specified number is scheduled to be relocated to at least one of the destination locations, and the computational device is further configured to reduce the number of the set of objects in response to computing a relocation destination for each of the objects. In some embodiments, the computational device is also configured to generate a new relocation route in response to the mobile electronic device diverting from the relocation route. In some embodiments, the computational device is also configured to transmit the new relocation route to the mobile electronic device.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method of generating a route for relocating objects, according to embodiments of the present disclosure.

FIG. 2 is a flowchart illustrating another exemplary method of generating a route for relocating objects, according to embodiments of the present disclosure.

FIG. 3 is a flowchart illustrating another exemplary method of generating a route for relocating objects, according to embodiments of the present disclosure.

FIG. 4 is a flowchart illustrating another exemplary method of generating a route for relocating objects, according to embodiments of the present disclosure.

FIG. 5A shows an exemplary relocation route displayed on a mobile electronic device, according to embodiments of the present disclosure.

FIG. 5B shows another exemplary relocation route displayed on a mobile electronic device, according to embodiments of the present disclosure.

FIG. 5C shows another exemplary relocation route displayed on a mobile electronic device, according to embodiments of the present disclosure.

FIG. 5D shows another exemplary relocation route displayed on a mobile electronic device, according to embodiments of the present disclosure.

FIG. 6 is a diagram of an exemplary network environment suitable for a distributed implementation of an exemplary embodiment of the present disclosure.

FIG. 7 is a block diagram of an exemplary computing device that can be used to perform exemplary processes in accordance with an exemplary embodiment of the present disclosure.

### DETAILED DESCRIPTION

Following below are more detailed descriptions of various concepts related to, and embodiments of, inventive methods, apparatus, and systems for generating a route for relocating objects. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

Example methodologies, systems, apparatus, and non-transitory computer-readable media are described herein to facilitate generating routes for relocating objects. Objects often need to be relocated to various geographical locations within a facility, and a relocation route can be calculated for relocating a number of objects to their respective destination locations. However, computing relocation destinations and generating a relocation route poses a number of non-trivial challenges. According to conventional techniques, a relocation route is self-chosen by the individual responsible for relocating the objects or is chosen based on the proximity of the destination locations to a starting location. However, objects may have multiple possible locations to which they may be relocated, and the individual responsible for relocating the objects may not know which location would be best for returning the objects without visiting all the possible locations and then backtracking to the best location. For example, if an object could be relocated to any one of three possible locations, but two of those locations were at maximum capacity, the individual would have to visit all three locations before successfully relocating the object. Furthermore, the individual would require a high level of knowledge of the facility's layout and object locations in order to properly relocate objects.

In accordance with some embodiments of the present disclosure, a system for generating a route for relocating objects is disclosed. Objects can be deposited in an area at a first geographical location in order to be relocated to their respective destination locations. The area can include a first electronic scanning device configured to identify each of the objects to be relocated as they are deposited in the area. In exemplary embodiments, some of the objects to be relocated can be associated with RFID tags, and the first electronic scanning device can include an RFID reader. Once an object has been identified within the area at the first geographical location, it can be added to a relocation database including a list of objects intended for relocation. Using RFID technology to automatically determine if an object has been deposited in the first geographical location provides rapid object identification and can allow the system to rapidly begin the object relocation process. Additionally due to the serialized nature of RFID tagging a computational device in communication with the RFID reader can determine the location of origin of the objects, as well as other object-specific information. Objects not associated with RFID tags can be identified manually using, for example, an optical reader configured to read machine readable features associated with those objects.

In exemplary embodiments, once the objects to be relocated have been identified in the first geographical location, a computing device can retrieve object relocation data and relocation capacity data from a first database for each of the objects. In exemplary embodiments, the object relocation data includes possible geographical locations for receiving each of the objects. The object relocation data can also include information relating to the location of origin of the objects or other object-specific data (e.g., an object's size, weight, etc.). The computational device can also retrieve relocation capacity data from the first database indicating an available capacity for each of the possible geographic locations, or possible destination locations, where an object could be relocated. The relocation capacity data can include, for example, information indicating the capacity of possible destination locations, the dimensions of possible destination locations, the status of any scheduled object relocation requests associated with the destination locations, the amount objects to be rescheduled as part of any scheduled object relocation requests, the current availability of objects at each of the possible destination locations, etc. As will be appreciated, the first database is described herein as a single database for illustrative purposes. However, multiple databases can be used to store the object relocation data and relocation capacity data described herein. The computational device can compute a relocation destination for each of the objects to be relocated based, at least in part, on the relocation capacity data for each of the possible destination locations. Based on the relocation destinations for each of the objects to be relocated, a relocation route is generated by the computational device.

In exemplary embodiments, the destination locations and relocation route are generated based on an efficient path for relocating the objects and taking into account the layout of the destination locations within a facility, the maximum capacity of each possible destination location, the current capacity of each possible destination location, information relating to the dimensions of each possible destination location, etc. Taking into account the relocation capacity data and object relocation data described above allows the computational device to generate an efficient relocation route in order to reduce the time required to relocate objects. Once the relocation route has been generated, it is transmitted to a mobile electronic device in order to display the relocation route to a user responsible for relocating the objects. The computational device also has the ability to dynamically update/modify the relocation route due to interruptions in the relocation process, or any changes to the relocation capacity data after the user has begun relocating objects. The mobile electronic device can interactively display the relocation route to the user. In exemplary embodiments, the mobile electronic device can display a graphical representation of the relocation destinations, as well as a graphical representation of the location of the mobile electronic device with respect to the relocation route. The mobile electronic device can also be used to communicate additional tasks to the user while the user is relocating objects. For example, in exemplary embodiments, the mobile electronic device can prompt the user to retrieve objects from locations along the relocation route and return those objects to the first geographical location.

In exemplary embodiments, a request may exist for one or more objects to be retrieved at the first geographical location, or a specified number of objects may be scheduled to be relocated to one or more of the destination locations. In response to a request for one or more of the objects to be retrieved from the first geographical location, the computational device can dynamically omit those objects from the relocation route. If a specified number of objects are scheduled to be relocated to one or more of the destination locations, the computational device can reduce the number of objects scheduled for relocation in response to computing a relocation destination for the objects to be relocated from the first geographical location.

In exemplary embodiments, once an object has been relocated to its corresponding destination location, the user can acknowledge that the action is completed, which will prompt the computational device to update a database such that the relocated item is now indicated as available at the relocation destination. If the relocated object is associated with an RFID tag, a second RFID reader at the destination location can determine whether the object has been properly relocated and prompt the computational device to update the database such that the relocated item is now indicated as available at the relocation destination. Using an RFID reader at the destination location can automatically identify when an object has been relocated properly and also help identify the amount of time spent on relocating the object. Updating the database only after objects have been successfully relocated increases the accuracy of the database such that only objects actually available at their destination locations are listed as available.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

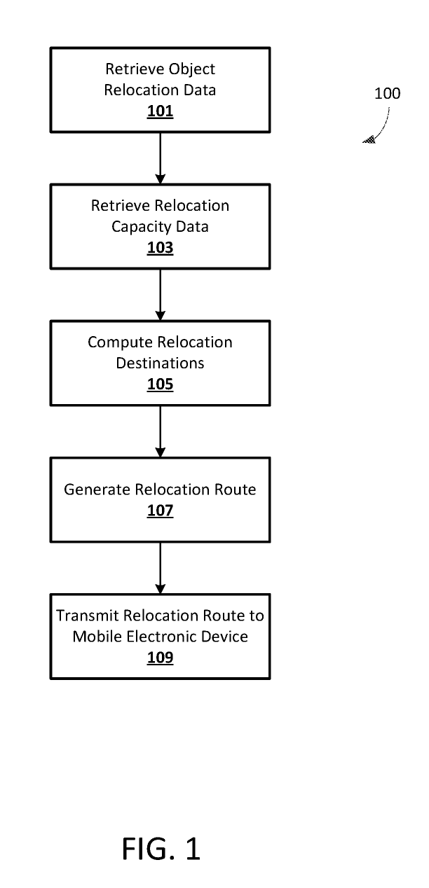

FIG. 1 is a flowchart illustrating an exemplary method 100 for generating a route for relocating objects. It will be appreciated that the method is programmatically performed by one or more computer-executable processes executing on, or in communication with one or more servers described further below. In exemplary embodiments, objects to be relocated are deposited in an area at a first geographical location, and the area includes a first electronic scanning device configured to identify each object to be relocated as they are deposited in the area. In step 101, a computational device retrieves object relocation data from a first database for each of the objects identified by the first electronic scanning device. The object relocation data includes data indicating possible geographic locations for receiving each of the objects. In exemplary embodiments, the first electronic scanning device is an RFID reader and each of the objects has an RFID tag. In such embodiments, the RFID reader reads the RFID tag associated with each of the objects as they enter the area.

In step 103, the computational device retrieves relocation capacity data from the first database for each of the objects to be relocated. The relocation capacity data includes data indicating an available capacity for each of the possible geographic locations.

In step 105, the computational device computes, via a relocation destination module, a relocation destination for each of the objects to be relocated based on the relocation capacity data corresponding to each of the possible geographic locations. As discussed above, when an object can be relocated to any number of locations within a facility, the computational device takes into account the capacity of each location in order to determine an appropriate relocation destination for each object.

In step 107, the computational device generates a relocation route, via a relocation route module, for relocating the objects based on the relocation destination computed for each of the objects to be relocated. As discussed above, the relocation route is an efficient path for relocating each of the objects to their respective relocation destination, and therefore the relocation route will not necessarily begin with the relocation destination closest to the first geographical location. In exemplary embodiments, the entire number of objects to be relocated will be taken into account in generating the relocation destination and the relocation route.

In step 109, the computational device transmits the relocation route to a mobile electronic device configured to interactively display the relocation route to a user.

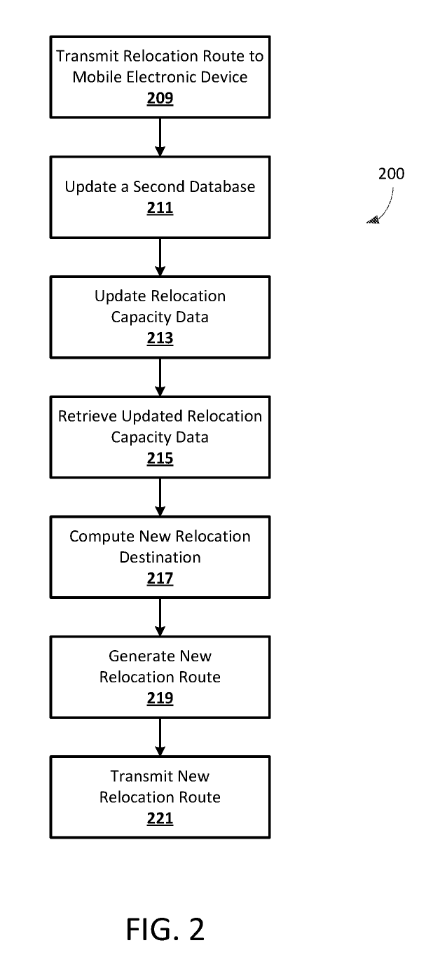

FIG. 2 is a flowchart illustrating another exemplary method 200 for generating a route for relocating objects. It will be appreciated that the method is programmatically performed by one or more computer-executable processes executing on, or in communication with one or more servers described further below. In exemplary embodiments, the relocation destinations can be computed and the relocation route generated as discussed above in reference to FIG. 1, steps 101-107. In step 209, the computational device transmits the relocation route to a mobile electronic device configured to interactively display the relocation route to a user.

In step 211, a second database is updated in response to the objects being relocated to their respective relocation destinations. The second database is updated to increment data associated with a physical quantity of each of the objects at each relocation destination. In exemplary embodiments, a second electronic scanning device is located at a second geographical location, and the second electronic scanning device can identify at least a subset of the objects to be relocated. In response to identifying at least a subset of the objects at the second geographical location, a second database can be updated to increment data associated with a physical quantity of the objects at each relocation destination.

In step 213, the relocation capacity data is updated in response to a change in the available capacity for at least one of the relocation destinations. For example, if additional objects are placed in one of the relocation destinations before the user is able to relocate objects at that location, then the available capacity corresponding to that location can be updated.

In step 215, the computational device can retrieve updated relocation capacity data corresponding to one or more of the relocation destinations. Once the updated relocation capacity data is retrieved, a new relocation destination is computed in step 217, via a relocation destination module, for at least one of the objects to be relocated. A new relocation route is generated in step 219, via a relocation route module, in response to the new relocation destination, and the new relocation route is transmitted to the mobile electronic device in step 221 to dynamically update the route being followed by the user.

In addition to, or in the alternative of, generating a new relocation route in response to a new relocation destination, the computational device and/or the mobile electronic device can generate a new route in response to detecting that the mobile electronic device has diverted from the initial relocation route. For example, while the user is traveling along the initial relocation route with the mobile electronic device, the user may divert from the initial relocation route in order to perform a separate task, or for any number of reasons. A processor of the mobile electronic device can determine the location of the mobile electronic device with respect to the relocation route based on, for example, wireless broadcasts from wireless access points that are geographically distributed throughout the facility. Once the user has diverted from the initial relocation route, it may not be efficient for the user to retrace their steps and resume from the spot where they diverted from the relocation route. Instead, the mobile electronic device can generate a new relocation route starting at the current location of the mobile electronic device and continuing to the relocation destinations that had not been previously passed.

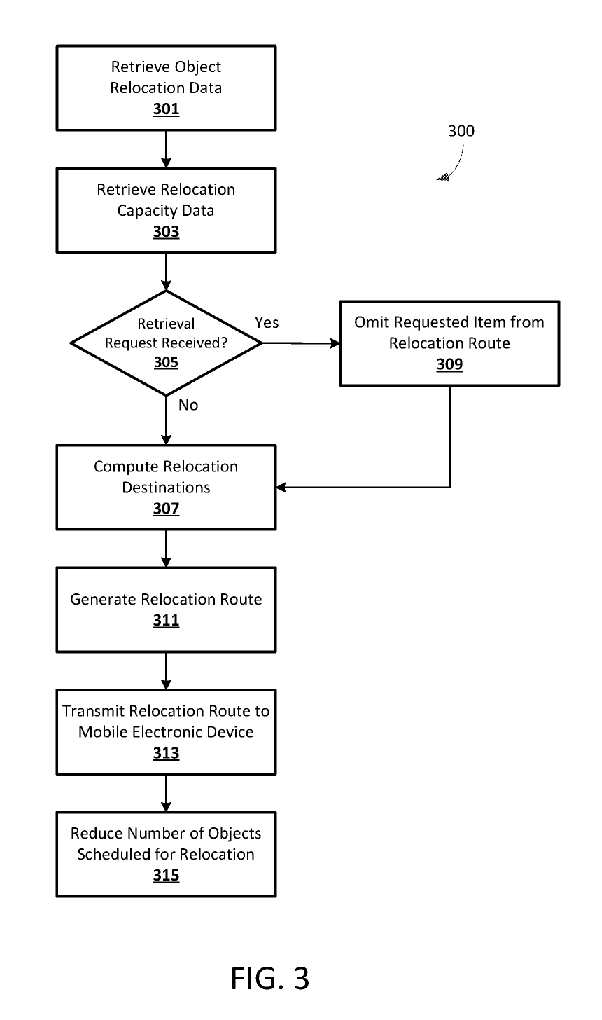

FIG. 3 is a flowchart illustrating another exemplary method 300 for generating a route for relocating objects. It will be appreciated that the method is programmatically performed by one or more computer-executable processes executing on, or in communication with one or more servers described further below. In exemplary embodiments, objects to be relocated are deposited in an area at a first geographical location, and the area includes a first electronic scanning device configured to identify each object to be relocated as they are deposited in the area. In step 301, a computational device retrieves object relocation data from a first database for each of the objects identified by the first electronic scanning device. The object relocation data includes data indicating possible geographic locations for receiving each of the objects. In exemplary embodiments, the first electronic scanning device is an RFID reader and each of the objects has an RFID tag. In such embodiments, the RFID reader reads the RFID tag associated with each of the objects as they enter the area.

In step 303, the computational device retrieves relocation capacity data from the first database for each of the objects to be relocated, The relocation capacity data includes data indicating an available capacity for each of the possible geographic locations.

In step 305, the computational device determines whether a retrieval request has been received for at least one of the objects to be relocated. For example, a retrieval request can be received requesting that one or more of the objects be retrieved from the facility at the first geographical location. If a retrieval request has been received, the objects requested can be omitted from the relocation route in step 309. In step 307, the computational device computes, via a relocation destination module, a relocation destination for each of the remaining objects not subject to a retrieval request.

If no retrieval request is received in step 305, the computational device computes in step 307 a relocation destination for each of the objects to be relocated based on the relocation capacity data corresponding to each of the possible geographic locations. As discussed above, when an object can be relocated to any number of locations within a facility, the computational device takes into account the capacity of each location in order to determine an appropriate relocation destination for each object.

In step 311, the computational device generates, via a relocation route module, a relocation route for relocating the objects based on the relocation destination computed for each of the objects to be relocated. As discussed above, the relocation route is an efficient path for relocating each of the objects to their respective relocation destination, and therefore the relocation route will not necessarily begin with the relocation destination closest to the first geographical location.

In step 313, the computational device transmits the relocation route to a mobile electronic device configured to interactively display the relocation route to a user.

In exemplary embodiments, a set of objects is scheduled to be relocated to at least one of the destination locations. The set of objects scheduled for relocation has a specified number, and in step 315, the number of objects scheduled for relocation to at least one of the destination locations is reduced in response to the computational device computing a relocation destination for each of the objects to be relocated.

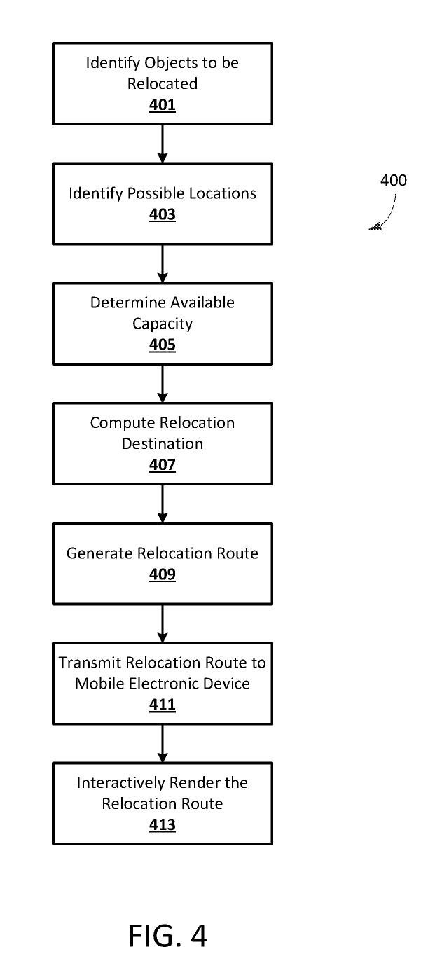

FIG. 4 is a flowchart illustrating another exemplary method 400 for generating a route for relocating objects. It will be appreciated that the method is programmatically performed by one or more computer-executable processes executing on, or in communication with one or more servers described further below. In exemplary embodiments, objects to be relocated are deposited in an area at a first geographical location, and the area includes a first RFID reader configured to identify each of a first subset of the objects associated with RFID tags. Each of the first subset of objects are identified by the first RFID reader as they are deposited in the area. The area also includes an optical reader configured to identify each of a second subset of the objects deposited in the area. In step 401, objects from the first subset of objects and the second subset of objects are identified at the first geographical location. In exemplary embodiments, the first RFID reader is configured to identify objects from the first subset of objects and the optical reader is configured to identify objects from the second subset of objects.

In step 403, the computational device identifies possible geographical locations for receiving each of the objects. In exemplary embodiments, the computational device can retrieve information from a database related to possible geographical locations where the objects can be relocated within a facility.

In step 405, the computational device determines the available capacity for each of the possible geographic locations. In exemplary embodiments, the computational device can retrieve information from a database related to the capacity of various locations within the facility to receive objects.

In step 407, the computational device computes, via a relocation destination module, a relocation destination for each of the objects based on the available capacity for each of the possible geographical locations. For example, if an object could be relocated to any one of three possible locations within a facility, but the first two of those locations were at maximum capacity, the computational device can compute that the third location should be the relocation destination.

In step 409, the computational device generates, via a relocation route module, a relocation destination route for relocating the objects based on the relocation destination computed for each of the objects. As discussed above, the relocation route is an efficient path for relocating each of the objects to their respective relocation destination, and therefore the relocation route will not necessarily begin with the relocation destination closest to the first geographical location.

In step 411, the computational device transmits the relocation route to a mobile electronic device. In exemplary embodiments, the mobile electronic device includes a processor, a display, memory, and a wireless interface. In step 413, the relocation route is received by the wireless interface of the mobile electronic device, and the processor of the mobile electronic device is configured to store the relocation route in memory and interactively render the relocation route on the display. In exemplary embodiments, the processor of the mobile electronic device is configured to render an image of each relocation destination on the display when the processor determines that the mobile electronic device is in proximity to each relocation destination. The processor can determine that the mobile electronic device is in proximity to each relocation destination based on wireless broadcasts from geographically distributed wireless access points that are received via the wireless interface of the mobile electronic device. In exemplary embodiments, the mobile electronic device is configured to dynamically update a current location of the mobile electronic device with respect to the relocation route as the mobile electronic device travels along the relocation route. In exemplary embodiments, a second RFID reader can be disposed at a second geographical location along the relocation route, and the computational device can update a database in response to the second RFID reader identifying at least one of the objects in the first subset at the second geographical location. The database can be updated to increment data associated with an available number of objects located at the relocation destination associated with one or more of the objects. For example, if an object is intended to be relocated to the second geographical location, and the second RFID reader identifies that the object has been placed in that area, the database can be updated to indicate that the object has been relocated and is now available at the second geographical location. In exemplary embodiments, the second RFID reader can identify that an object has been placed in a specific location by detecting static x, y coordinates of an RFID tagged object at the location. If, for example, the x, y coordinates of an RFID tagged object are static after three seconds, and the user has moved away from the area, the computational device can determine that the RFID tagged object has been relocated. In exemplary embodiments, the computational device can then automatically close a relocation task without user input.

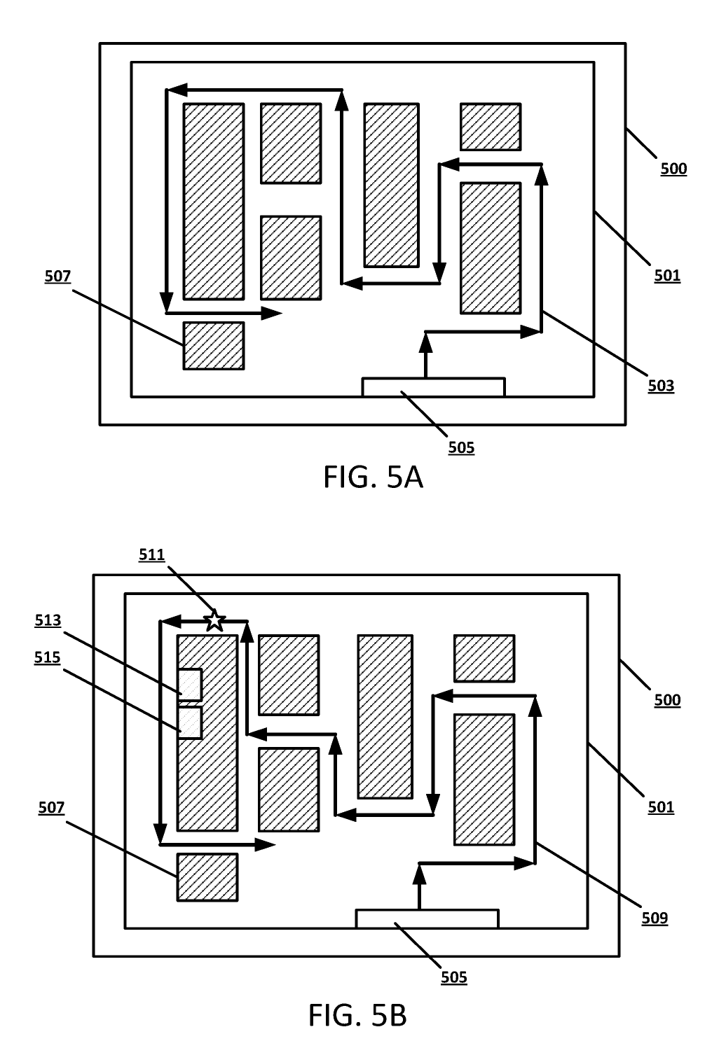

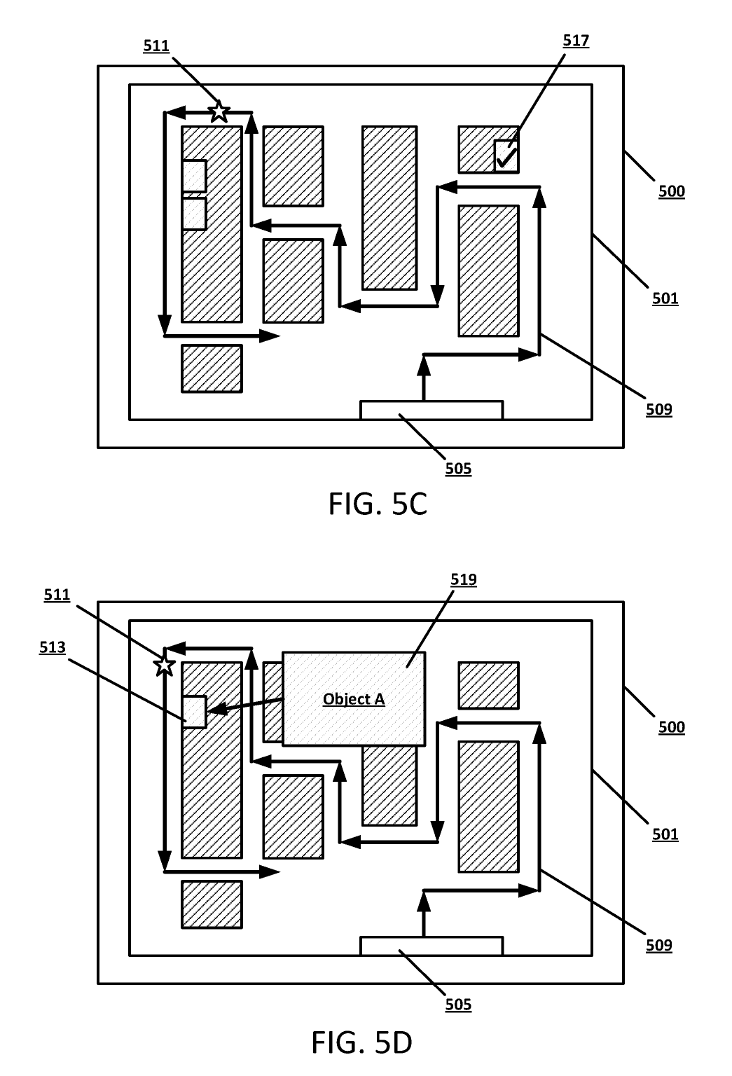

FIG. 5A shows an exemplary relocation route displayed on a mobile electronic device, according to embodiments of the present disclosure. As can be seen in this embodiment, the mobile electronic device 500 renders a relocation route 503 on a display 501. The relocation route begins at the first geographical location 505, where the first electronic scanning device, described above, is located. The relocation route 503 directs the user of the mobile electronic device 500 around various areas 507 within a facility to relocate objects. In exemplary embodiments, the relocation route 503 can be updated based on updated relocation capacity data corresponding to one or more of the relocation destinations along the relocation route 503.

FIG. 5B shows another exemplary relocation route displayed on a mobile electronic device, according to embodiments of the present disclosure. As can be seen in this embodiment, the mobile electronic device 500 renders a relocation route 509 on the display 501. The relocation route begins at the first geographical location 505, where the first electronic scanning device, described above, is located. The mobile electronic device also renders a graphical indication 511 of a current geographical location of the mobile electronic device 500 with respect to the relocation route 509 as the mobile electronic device 500 travels along the relocation route 509. In exemplary embodiments, the display 501 of the mobile electronic device 500 also shows a graphical representation 513 of one of the relocation destinations. In exemplary embodiments, the processor of the mobile electronic device renders the image 513 of the relocation destination when the processor determines that the mobile electronic device is in proximity of the relocation destination. As discussed above, the processor of the mobile electronic device 500 can determine that the mobile electronic device 500 is in proximity of the relocation destination 513 based on wireless broadcasts from wireless access points that are geographically distributed throughout the facility. In exemplary embodiments, a second electronic scanning device 515, such as a second RFID reader, is located at a second geographical location within the facility, and the second electronic scanning device 515 is configured to identify at least one of the objects at the second geographical location. For example, one or more of the objects can be associated with RFID tags, and the second electronic scanning device 515 can identify those objects at the second geographical location. In response to identifying one or more of the objects at the second geographical location, the computational device can update a database to increment data associated with a physical quantity of the objects at one of the relocation destinations.

FIG. 5C shows another exemplary relocation route displayed on a mobile electronic device, according to embodiments of the present disclosure. As can be seen in this embodiment, the mobile electronic device 500 renders a relocation route 509 on the display 501. The relocation route begins at the first geographical location 505, where the first electronic scanning device, described above, is located. The mobile electronic device also renders a graphical indication 511 of a current geographical location of the mobile electronic device 500 with respect to the relocation route 509 as the mobile electronic device 500 travels along the relocation route 509. In exemplary embodiments, the display 501 of the mobile electronic device 500 also shows a graphical representation 517 of a previous relocation destination where the user has successfully relocated one or more objects in response to sensing that the one or more objects have been disposed at the previous relocation destination. For example, an RFID reader can be disposed at or proximate to the relocation destination such that in response to placing the one or more objects at the relocation destination, the RFID reader can read RFID tags associated with the one or more objects to confirm placement of the one or more objects. In response to reading the RFID tags, the RFID reader can communicate that the RFID tags associated with the one or more objects has been read to the computational device, and the computational device can transmit instructions to the mobile device to render the graphical representation 517 at the relocation destination to indicate to the user that the computational device confirms placement of the one or more objects at the appropriate relocation destination. In exemplary embodiments, the graphical representation 517 can include a check mark, or other visual indication that an object has successfully been relocated to that location.

FIG. 5D shows another exemplary relocation route displayed on a mobile electronic device, according to embodiments of the present disclosure. As can be seen in this embodiment, the mobile electronic device 500 renders a relocation route 509 on the display 501. The relocation route begins at the first geographical location 505, where the first electronic scanning device, described above, is located. The mobile electronic device 500 also renders a graphical indication 511 of a current geographical location of the mobile electronic device 500 with respect to the relocation route 509 as the mobile electronic device 500 travels along the relocation route 509. In exemplary embodiments, the display 501 of the mobile electronic device 500 also shows a graphical representation 513 of one of the relocation destinations. In exemplary embodiments, the processor of the mobile electronic device renders the image 513 of the relocation destination when the processor determines that the mobile electronic device 500 is in proximity of the relocation destination. As discussed herein, the processor of the mobile electronic device 500 can determine that the mobile electronic device 500 is in proximity of the relocation destination based on wireless broadcasts from wireless access points that are geographically distributed throughout the facility. Once the processor of the mobile electronic device 500 determines that it is in proximity to the relocation destination, the mobile electronic device 500 can render an image of an object, for example, object A 519, pointing to the destination location for that object. In exemplary embodiments, the size or location of the object image 519 is determined so that it does not block the image 513 of the destination location, the graphical indication 511 of the user's current location, or the relocation route 509. In exemplary embodiments, the object image 519 can be dynamically relocated or moved with respect to the underlying image of the relocation route 509 as the mobile electronic device 500 moves along the relocation route 509. In alternative embodiments, the underlying relocation route 509 or the image 513 of the destination location can be dynamically relocated or otherwise altered in appearance to become automatically viewable to the user when the object image 519 is rendered.

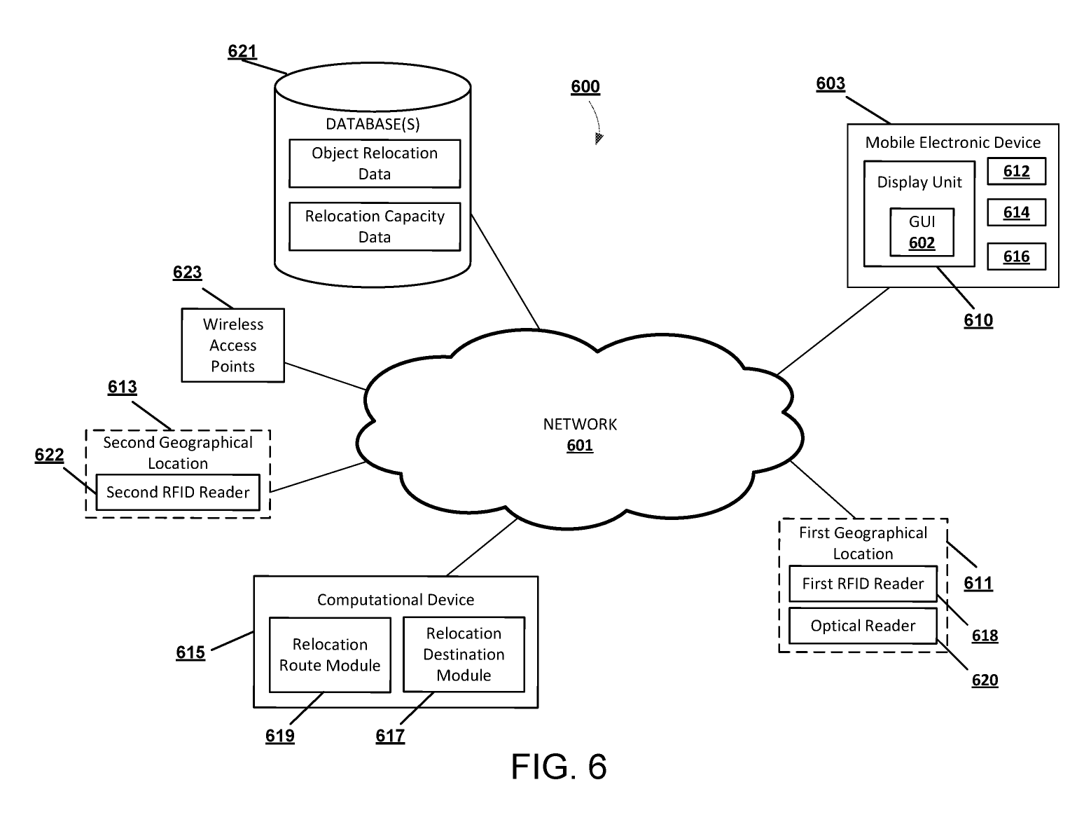

FIG. 6 illustrates a network diagram depicting a system 600 suitable for a distributed implementation of exemplary embodiments. The system 600 can include a network 601, mobile electronic device 603, a first RFID reader 618 and an optical reader 620 at a first geographical location 611, a second RFID reader 622 at a second geographical location 613, a computational device 615, wireless access points 623, and a database 621. As will be appreciated, various distributed or centralized configurations may be implemented. In exemplary embodiments, the computational device 615 can store a relocation destination module 617 and a relocation route module 619, each of which can implement one or more of the processes described herein with reference to FIGS. 1-4, or portions thereof. The database 621 can store the object relocation data and the relocation capacity data, in exemplary embodiments.

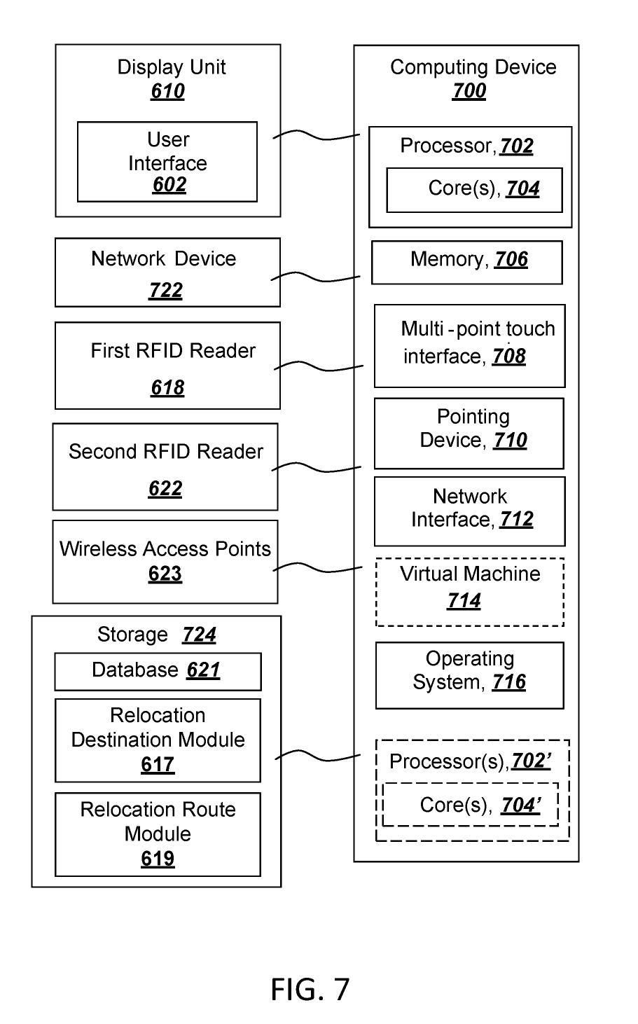

In exemplary embodiments, the mobile electronic device 603 may include a display unit 610, which can display a GUI 602 to a user of the mobile electronic device. The mobile electronic device can also include a memory 612, processor 614, and a wireless interface 616. In some embodiments, the computational device 615 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, tablets, netbooks, and the like. The mobile electronic device 603 may include some or all components described in relation to computing device 700 shown in FIG. 7.

As a non-limiting example application, the mobile electronic device 603, can be part of a store infrastructure and aid in performing various transactions related to sales and other aspects of a store. Being part of a store's infrastructure, the mobile electronic device 603 may be fixedly installed within the store or may be fixedly installed or operational outside of the store. In some embodiments, the mobile electronic device 603 may be a mobile device that can be used within the store, and is not physically installed or attached to one particular location within the store. The mobile electronic device 603 may also include various external or peripheral devices to aid in performing sales transactions and other duties. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, and the like. Examples of payment terminals include, but are not limited to, card readers, pin pads, signature pads, signature pens, Square™ registers, LevelUp™ platform, cash or change deposit devices, cash or change dispensing devices, coupon accepting devices, and the like. The mobile electronic device 603 may connect to a network 601 via a wired or wireless connection. The mobile electronic device 603 may include one or more applications such as, but not limited to, a web browser, a sales transaction application, an object reader application, and the like.

In exemplary embodiments, the mobile electronic device 603, first RFID reader 618, optical reader 620, second RFID reader 622, computational device 615, and database 621 may be in communication with each other via a communication network 601. The communication network 601 may include, but is not limited to, the Internet, an intranet, a LAN (Local Area Network), a WAN (Wide Area Network), a MAN (Metropolitan Area Network), a wireless network, an optical network, and the like. In one embodiment, computational device 615 and mobile electronic device 603 can transmit instructions to each other over the communication network 601. In exemplary embodiments, the object relocation data and relocation capacity data can be stored at database 621 and received at the computational device 615 in response to a service performed by a database retrieval application.

FIG. 7 is a block diagram of an exemplary computing device 700 that can be used in the performance of any of the example methods according to the principles described herein. The computing device 700 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 706 included in the computing device 700 can store computer-readable and computer-executable instructions or software for implementing exemplary embodiments and programmed to perform processes described above in reference to FIGS. 1-4. The computing device 700 also includes processor 702 and associated core 704, and optionally, one or more additional processor(s) 702′ and associated core(s) 704′ (for example, in the case of computer systems having multiple processors/cores), for executing computer-readable and computer-executable instructions or software stored in the memory 706 and other programs for controlling system hardware. Processor 702 and processor(s) 702′ can each be a single core processor or multiple core (704 and 704′) processor.

Virtualization can be employed in the computing device 700 so that infrastructure and resources in the computing device can be shared dynamically. A virtual machine 714 can be provided to handle a process running on multiple processors so that the process appears to be using only one computing resource rather than multiple computing resources. Multiple virtual machines can also be used with one processor.

Memory 706 can be non-transitory computer-readable media including a computer system memory or random access memory, such as DRAM, SRAM, EDO RAM, and the like. Memory 706 can include other types of memory as well, or combinations thereof.

A user can interact with the computing device 700 through a display unit 610, such as a touch screen display or computer monitor, which can display one or more user interfaces 602 that can be provided in accordance with exemplary embodiments. The computing device 700 can include or be in communication with a first RFID reader 618, a second RFID reader 622, or wireless access points 623, in some embodiments. The computing device 700 can also include other I/O devices for receiving input from a user, for example, a keyboard or any suitable multi-point touch interface 708, a pointing device 710 (e.g., a pen, stylus, mouse, or trackpad). The multi-point touch interface 708 and the pointing device 710 can be coupled to the display unit 610. The computing device 700 can include other suitable conventional I/O peripherals.

The computing device 700 can also include one or more storage devices 724, such as a hard-drive, CD-ROM, or other non-transitory computer readable media, for storing data and computer-readable instructions and/or software, such as a relocation destination module 617 and a relocation route module 619 that can implement exemplary embodiments of the methods and systems as taught herein, or portions thereof. Exemplary storage device 724 can also store one or more databases 621 for storing any suitable information required to implement exemplary embodiments. The databases can be updated by a user or automatically at any suitable time to add, delete, or update one or more items in the databases. Exemplary storage device 724 can store one or more databases 621 for storing the object relocation data, relocation capacity data, and any other data/information used to implement exemplary embodiments of the systems and methods described herein.

The computing device 700 can include a network interface 712 configured to interface via one or more network devices 722 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 712 can include a built-in network adapter, network interface card, PCMCIA network card, card bus network adapter, wireless network adapter, USB network adapter, modem or any other device suitable for interfacing the computing device 700 to any type of network capable of communication and performing the operations described herein. Moreover, the computing device 700 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 700 can run any operating system 716, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 716 can be run in native mode or emulated mode. In an exemplary embodiment, the operating system 716 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for generating a route for relocating objects, the system comprising:
a mobile electronic device including a processor, a display, a memory, and a wireless interface;
an area at a first geographic location at which a plurality of objects to be relocated are deposited, the area including:
a first RFID reader configured to identify each of a first subset of the plurality of objects associated with RFID tags as each of the plurality of objects in the first subset is deposited in the area; and
an optical reader configured to identify each of a second subset of the plurality of objects deposited in the area;
a computational device in communication with the mobile electronic device, the first RFID reader, and the optical reader, the computational device configured to:
identify possible geographic locations for receiving each of the plurality of objects;
determine an available capacity for each of the possible geographic locations;
compute a relocation destination for each of the plurality of objects based on the available capacity for each of the possible geographic locations;
generate a relocation route for relocating the plurality of objects based on the relocation destination computed for each of the plurality of objects; and
transmit the relocation route to the mobile electronic device,
wherein the relocation route is received by the wireless interface of the mobile electronic device, and the processor of the mobile electronic device is configured to store the relocation route in memory and interactively render the relocation route on the display.

2. The system of claim 1, wherein the processor of the mobile electronic device is configured to render an image of each relocation destination on the display when the processor determines that the mobile electronic device is in a proximity of each relocation destination based on wireless broadcasts from geographically distributed wireless access points that are received via the wireless interface of the mobile electronic device.

3. The system of claim 2, wherein the mobile electronic device is configured to dynamically update a current location of the mobile electronic device with respect to the relocation route as the mobile electronic device travels along the relocation route.

4. The system of claim 1, further comprising a second RFID reader disposed at a second geographical location along the relocation route, wherein the computational device is further configured to update a second database in response to the second RFID reader identifying at least one of the plurality of objects in the first subset at the second geographical location, wherein the second database is updated to increment data associated with a physical quantity of the at least one of the plurality of objects at the relocation destination associated with the at least one of the plurality of objects.

5. A system for generating a route for relocating objects, the system comprising:
an area at a first geographic location at which a plurality of objects to be relocated are deposited, the area including a first electronic scanning device configured to identify each of the plurality of objects to be relocated as each of the objects are deposited in the area; and
a computational device configured to:
retrieve object relocation data and relocation capacity data from a first database for each of the plurality of objects identified by the first electronic scanning device, the object relocation data indicating possible geographic locations for receiving each of the plurality of objects and the relocation capacity data indicating an available capacity for each of the possible geographic locations;
compute a relocation destination for each of the plurality of objects based on the relocation capacity data for each of the possible geographic locations;
generate a relocation route for relocating the plurality of objects based on the relocation destination computed for each of the plurality of objects; and
transmit the relocation route to a mobile electronic device configured to interactively display the relocation route to a user.

6. The system of claim 5, wherein the first electronic scanning device is an RFID reader and each of the plurality of objects has an RFID tag, wherein the RFID reader reads the RFID tag associated with each of the plurality of objects as each of the plurality of objects enters the area.

7. The system of claim 5, wherein the computational device is further configured to update a second database in response to the plurality of objects being relocated to their respective relocation destinations, wherein, the second database is updated to increment data associated with a physical quantity of each of the plurality of objects at each relocation destination.

8. The system of claim 5, further comprising a second electronic scanning device located at a second geographical location outside of the area, the computational device further configured to update a second database in response to the second electronic scanning device identifying at least a subset of the plurality of objects at the second geographic location.

9. The system of claim 5, wherein the computational device is further configured to update the relocation capacity data in response to a change in the available capacity for at least one of the relocation destinations.

10. The system of claim 9, wherein the computational device is further configured to:
retrieve updated relocation capacity data;
compute a new relocation destination for at least one of the plurality of objects for which the relocation route was computed in response to the updated relocation capacity data;
generate a new relocation route in response to the new relocation destination; and
transmit the new relocation route to the mobile electronic device.

11. The system of claim 5, wherein the computational device is further configured to omit at least one of the plurality of objects from the relocation route in response to a retrieval request for the at least one object from the first geographical location.

12. The system of claim 5, wherein a set of objects having a specified number is scheduled to be relocated to at least one of the destination locations, and wherein the computational device is further configured to reduce the number of the set of objects in response to computing a relocation destination for each of the plurality of objects.

13. The system of claim 5, wherein the computational device is further configured to:
generate a new relocation route in response to the mobile electronic device diverting from the relocation route; and
transmit the new relocation route to the mobile electronic device.

14. A method for generating a route for relocating objects, the method comprising:
retrieving object relocation data and relocation capacity data from a first database for each of a plurality of objects to be relocated identified by a first electronic scanning device at an area at a first geographical location, the object relocation data indicating possible geographic locations for receiving each of the plurality of objects and the relocation capacity data indicating an available capacity for each of the possible geographic locations;
computing a relocation destination for each of the plurality of objects based on the relocation capacity data for each of the possible geographic locations;
generating a relocation route for relocating the plurality of objects based on the relocation destination computed for each of the plurality of objects; and
transmitting the relocation route to a mobile electronic device configured to interactively display the relocation route to a user.

15. The method of claim 14, further comprising updating a second database in response to the plurality of objects being relocated to their respective relocation destinations, wherein the second database is updated to increment data associated with a physical quantity of each of the plurality of objects at each relocation destination.

16. The method of claim 14, further comprising updating a second database in response to a second electronic scanning device located at a second geographical location outside of the area identifying at least a subset of the plurality of objects at the second geographic location, wherein the second database is updated to increment data associated with a physical quantity of each of the plurality of objects at each relocation destination.

17. The method of claim 14, further comprising updating the relocation capacity data in response to a change in the available capacity for at least one of the relocation destinations.

18. The method of claim 17, further comprising:
retrieving updated relocation capacity data;
computing a new relocation destination for at least one of the plurality of objects in response to the updated relocation capacity data;
generating a new relocation route in response to the new relocation destination; and
transmitting the new relocation route to the mobile electronic device.

19. The method of claim 14, further comprising omitting at least one of the plurality of objects from the relocation route in response to a retrieval request for the at least one object from the first geographical location.

20. The method of claim 14, wherein a set of objects having a specified number is scheduled to be relocated to at least one of the destination locations, and wherein the method further comprises reducing the number of the set of objects in response to computing a relocation destination for each of the plurality of objects.
